(19) United States
(12) Patent Application Publication
(10) Pub. No.: US 2002/0105955 A1
(43) Pub. Date: Aug. 8, 2002

(54) Ethernet digital storage (EDS) card and satellite transmission system including faxing capability

(76) Inventors: Roswell R. Roberts III, San Diego, CA (US); Ian Lerner, La Jolla, CA (US); Lowell E. Teschmacher, Carlsbad, CA (US)

Correspondence Address: McAndrews, Held & Malloy, Ltd., 500 W. Madison Street, 34th Floor, Chicago, IL, 60661, US

(21) Appl. No.: 09/990,731

(22) Filed: Nov. 13, 2001

Related U.S. Application Data
(63) Continuation-in-part of application No. 09/425,118, filed on Oct. 22, 1999.
(63) Continuation-in-part of application No. 09/287,200, filed on Apr. 3, 1999, now Pat. No. 6,160,797.
(60) Provisional application No. 60/248,072, filed on Nov. 13, 2000.

(51) Int. Cl. H04L 12/28

(52) U.S. Cl. 370/401; 725/105

(57) ABSTRACT

An Ethernet Digital Storage (EDS) Card and satellite transmission system is provided for receiving, storing, and transmitting files including video, audio, fax, text, and multimedia files, especially files received via satellite transmission. In a preferred embodiment, a satellite system includes a receiver using the EDS Card. A data stream is received by the receiver and then may be stored at the receiver or directly routed as TCP/IP packets. Received or stored data files may be multicast. The EDS Card also includes an HTTP server for web access to the card parameters and any files stored on the card. A DHCP on the EDS card provides dynamic configuration of the card's IP address. The EDS card also includes a PPP and modem processor for file transmission, reception, and affidavit collection. The EDS card also includes an event scheduler for triggering files at a predetermined time or at an external prompt. A command processor keeps a built-in log of audio spots played and responds to a command originator when a command is received. Files may be transmitted from the EDS card via a M&C port, an Ethernet port, or an auxiliary RS-232 port. Files may be received by the EDS Card from a data stream from a satellite, a M&C port, an Ethernet port, or an auxiliary RS-232 port. The EDS card also provides time shifting and may be used without a satellite feed as an HTTP-controlled router with storage.

### BACKGROUND OF THE INVENTION

The present invention generally relates to an Ethernet Digital Storage (EDS) Card, satellite transmission system, and method for data delivery or advertising. More particularly, the present invention relates to an EDS Card for receiving, storing, and transmitting files including video, audio, text, fax, and multimedia files, especially files received via satellite transmission.

The effort to develop a system for error-free, time-crucial distribution of bandwidth consumptive files has driven the data delivery industry for some time. Within the broadcasting industry, especially radio broadcasting, private network systems have been developed to facilitate the distribution of audio files for subsequent radio broadcasting. These private network systems often use satellites as “bent-pipes” to deliver their content reliably and quickly. These private network systems have evolved from primitive repeaters to systems allowing the receiving station greater degrees of interaction and reliability.

The Internet is an enormous network of computers through which digital information can be sent from one computer to another. The Internet's strength—its high level of interconnectivity —also poses severe problems for the prompt and efficient distribution of voluminous digital information, particularly digitized imaging, audio, or video information, such as an audio broadcast transmission. Internet service providers (ISP's) have attempted to accelerate the speed of delivery of content to Internet users by delivering Internet content (e.g., TCP/IP packets) to the user through a satellite broadcast system. One such system is the direct-to-home (“DTH”) satellite delivery system such as that offered in connection with the trademark, “DirecPC.” In these DTH types of systems, each subscriber or user of the system must have: (i) access to a satellite dish; (ii) a satellite receiver connected to the satellite dish and mounted in the user's PC; and (iii) an Internet back channel in order to request information from Internet Web sites. The DTH system is thus quite costly, since each user must have its own receiver and connection to a satellite dish. The DTH system is also somewhat difficult to deploy since the satellite antenna and receiver is mounted in each DTH user's PC.

The DTH system also does not take advantage of pre-existing satellite systems, and it often is a single carrier system, dedicated to the delivery of Internet content to the user. It does not allow the user flexibility to receive, much less distribute to others, other types of services, such as non-Internet radio broadcast or faxing services for example. The DTH systems also typically modify the IP packets at the head end, thus introducing significant processing delay through the need to reconstruct packets on the receiving end.

DTH systems typically utilize the DVB standard, in which event the system might broadcast other services. DVB systems, however, utilize a statistical data carrier. For this and other reasons, the DVB systems often cause significant additional delay due to the need to reconstruct packets from the statistically multiplexed carrier sent through DVB system. DTH systems also add significant overhead to the data stream they provide, thus requiring additional bandwidth and associated costs in order to processes and deliver DVB data streams.

The DTH system is also typically quite limited in its bandwidth capabilities. The consumer DirecPC system, for example, is limited to 440 kbps, thus limiting its effectiveness as a reliable, flexible, and quick distribution vehicle for Internet content, particularly voluminous content, to all users of the system through the one carrier.

Another system used by ISP's and others to deliver Internet content through satellites is the use of commercial or professional quality satellite receivers in conjunction with traditional Internet routers connected into an ISP LAN or similar LAN for delivery of the received content through its LAN to its subscribers either on the LAN or through modems and telecommunications lines interconnecting the modems. (See Prior Art FIG. 3.) These types of separate receiver-and-router satellite systems have typically required use of traditional satellite data receivers with integrated serial (often RS-422) interfaces or data outputs. The data output is connected into the router, which then converts the data into Ethernet compatible output and routes and outputs the Ethernet onto the LAN.

The applicant has discovered that these prior art data receiver and separate router systems present many problems. For example, the traditional data receivers are relatively inflexible and support only one or two services; and the use of a separate router is expensive. In addition, these types of systems usually employ a DVB transport mechanism, which not well suited to transmitting Internet and similar types of content for a number of reasons. One reason is that, as noted above, the DVB transport protocol and mechanism add substantial delays into the system. Another is that, as the applicant has discovered, the DVB transport mechanism utilizes excessive amounts of bandwidth.

In addition, prior art data receiver and separate router systems often employ a separate storage memory, often linked to the router via a Local Area Network (LAN) which adds further expense, complication, and bandwidth consumption. Additionally, prior art receivers typically are unable to provide multicasting and expensive multicasting routers must be added to the system to support multicasting.

The applicants have attempted to solve many problems through the development of several prior art satellite data transmission systems and modules, available from StarGuide Digital Networks, Inc. of Reno, Nev., that may be added to a receiver including an Asynchronous Services Statistical Demux Interface Module, a Digital Video Decoder Module, an MX3 Digital Multimedia Mulitplexer, a Digital Audio Storage Module, and a Digital Multimedia Satellite Receiver.

With regard to the field of broadcasting, specifically the distribution of advertising materials and time-critical materials, several improvements have long been desired.

Typically, many corporations may desire to have an ad campaign “localized” or “regionalized,” for example by including the voice of a locally known celebrity. The corporation desiring to localize the ad campaign in the various localities would contract with local networks, such as radio networks in the localities to construct advertisements that were specific to an individual locale yet abided by general corporate guidelines. The local buys of advertising from the local advertising providers are then presented locally, for example, the advertising content may be distributed through the local radio stations.

Starguide recognized that the localization of advertisements or “spots” required a great deal of duplication of effort and expense. Additionally, Starguide recognized that performing the ad buys locally deprives the nationwide radio networks of advertising revenues which the nationwide networks could achieve more efficiency and in a broader scale. That is, the nationwide network may develop a single advertisement and provide a regionalized advertisement to the local networks.

Starguide recognized that the development of a cost effective system for providing regionalized advertisements would be very commercially valuable to nationwide advertisers in order to reduce their total advertising expenses and to nationwide networks to provide access to business opportunities typically reserved for regional agencies.

For example, spot localization and distribution is extremely cumbersome in prior art systems. Often prior art systems require audio tapes to be generated at a centralized location and then physically mailed to a local broadcaster, which is costly, labor intensive and not time effective. Starguide recognized that the development of a distribution system providing reliable, fast and efficient delivery of content as well as increased automation capability throughout the system may be of great use in data delivery enterprises such as nation ad campaign distribution and may lead to industry growth and increased profitability. For example, increased automation, ease of use and speed of distribution of a national ad campaign to a number of local broadcasters may allow increased broadcast advertising and may draw major advertising expenditures into national broadcasting advertising campaigns.

Additionally, Starguide also recognized that an advertisement distribution system providing additional functionality would also be highly desirable, particularly in the radio, TV and internet distribution industries. For example, the distribution system may be used to distribute data other than advertising data, such as fax data. By distributing data via a dedicated, internally controlled network, a user may achieve several benefits such as reduced communication fees and better control and tracking of data passing over the network. Furthermore, such an advertisement distribution system may be expandable to form a “mini-telco” or mini-telecommunications company providing many services to the users.

Additionally, Starguide further recognized that such an advertising distribution system which is more easily accessible by a user and may be interacted—with to a great degree would also be highly desirable. For example, the ability of the system to provide access via a web browser to advertising content and configuration parameters of the system may also be highly desirable.

### BRIEF SUMMARY OF THE INVENTION

A preferred embodiment of the present invention provides an Ethernet Digital Storage (EDS) Card operable in a satellite data transmission system for storing and routing any kind of data including audio, video, text, fax, image or multimedia files. Use of the preferred embodiment provides a satellite data transmission system with the ability to receive a multiplexed data stream of a variety of files, such as audio, video, data, fax, images, and other multimedia files. Received files may be demultiplexed and stored automatically on the EDS Card locally in a flash memory storage. Files stored in the flash memory storage may be retrieved later. Alternatively, received files may be routed by the EDS Card over a network such as a Local Area Network (LAN). In a preferred embodiment, audio files may be retrieved, mixed with external audio, further manipulated and output as audio output. All files stored in the flash memory storage may be transmitted externally via an Ethernet Port, an M&C Port or a modem-enabled Auxiliary RS-232 Port. In addition to a data stream received from a satellite, files may be uploaded to the flash memory storage via an Ethernet Port, an M&C Port or a modem-enabled Auxiliary RS-232 Port. The EDS Card provides efficient multicasting via an IGMP multicasting processor. The EDS Card includes an HTTP server and a DNS resolver allowing the operation of the EDS Card and the contents of the flash memory storage to be accessible remotely via a web browser. The EDS Card provides a satellite receiver with a digital data, video, or audio storage and local insertion device, web site, Ethernet output device and router.

Additionally, a preferred embodiment of the present invention provides a fax distribution system that provides a virtual private network for faxes to increase security and on-time deliverability of faxes, to replace transmission over standard telephony resources when the standard resources are faulty or intermittent, to minimize costs associated with faxing by directly transmitting faxes over the satellite network to a local fax machine for transmission to a local user, and to provide easy record keeping or backup of faxes.

Additionally, in a preferred embodiment, the faxing ability may be combined with the Ethernet routing and data storage capabilities of the EDS card, which is most preferably removable and field-insertable and upgradable.

These and many other aspects of a preferred embodiment of the present invention are discussed or apparent in the following detailed description of the preferred embodiments of the invention. It is to be understood, however, that the scope of the invention is to be determined according to the accompanying claims.

### Advantages of a Preferred Embodiment of the Invention

The various preferred embodiments of the present invention provide at least one, but not necessarily more than one of the following advantages:

To provide an EDS card capable of storing any kind of data, not just audio data. For example, the EDS card may be used to store text, numbers, instructions, images or video data.

To distribute TCP/IP compatible content by satellite.

To provides an Ethernet/Router card that may be mounted in a satellite receiver quickly, easily, and economically.

To provide a satellite receiver with the capability of receiving TCP/IP compatible content and routing and distributing it onto a LAN or other computer network without need for a router to route the content onto the LAN or network.

To provide a preferred card that may be hot swappable and may be removed from the receiver without interfering with any other services provided by the receiver.

To provide a preferred card that may be used in a receiver that may deliver other services, through other cards, in addition to those provided by the present invention itself. For example, other services, available from StarGuide Digital Networks, Inc. of Reno, Nev. that may be added to a receiver include an Asynchronous Services Statistical Demux Interface Module, a Digital Video Decoder Module, an MX3 Digital Multimedia Mulitplexer, a Digital Audio Storage Module, a Digital Audio Decoder, and a Digital Multimedia Satellite Receiver.

To provide satellite distribution of TCP/IP compatible content, eliminating the need for each PC receiving the content through the receiver to have its own dish or its own satellite receiver.

To provide satellite TCP/IP distribution to PC's without having a satellite receiver being mounted in a PC and subject to the instability of the PC environment.

To provide data services in addition to delivery of Internet content. Another advantage is that the satellite receiver in which the card is inserted preferably can provide yet additional services through other cards inserted in slots in the receiver.

To allow existing networks of satellite receivers to be adapted to deliver Internet services by mere insertion of the present cards in the receivers without having to replace the existing networks.

To provides the ability to deliver TCP/IP content to Ethernet LAN's without need for custom software.

To provide a system in which, both the overall system and the Ethernet/Router card in particular, process IP packets without modification or separation of the contents of the packets. The applicants' satellite transmission system and the present Ethernet/Router card are thus easier to implement; and since they process each IP packet as an entire block with no need to reconstruct packets on the receiving end, the system and the Ethernet/Router card more quickly process and route the IP packets from the head end to an associated LAN on the receiving end.

To provide an Ethernet portion of the card using an auto-negotiating 10/100 BT interface so that the card can integrate into any existing 10 BT or 100 BT LAN.

To provide a PPP connection to tie into an external modem so that the card can be tied to a distribution network via telco lines. This connection can be used for distribution as well as automatic affidavit and confirmation.

To provide a DHCP (Dynamic Host Configuration Protocol), which allows the card's IP address to be automatically configured on an existing LAN supporting DHCP. This eliminates the need too manually configure the card's IP address.

To provide a DNS (Domain Name Service) protocol to allow the card to dynamically communicate with host web servers no matter what their IP address is.

To provide an HTTP server (web server) so that the card may be configured or monitored via a standard Web Browser. Additionally, the files stored on the EDS CARD may be downloaded or upload via a standard web browser.

To provide an EDS card including an analog audio input port to allow a “live” feed to be mixed/faded with the locally stored audio. Additionally, an analog output is provided to allow auditioning of the local feed.

To provide an EDS Card having a relay input port that allows external command of the card's behavior. Additionally, the card may be commanded via an Ethernet link, an Auxiliary RS-232 Port, a Host Interface Processor, or a received data stream.

To provide an EDS Card including a scheduler which allows the card to act at predetermined times to, for example, play an audio file and, if desired, to automatically insert such content into another content stream being received and output by the receiver and card.

To provide an IGMP multicasting processor to provide efficient multicasting to an attached LAN. Alternatively, the IGMP multicasting processor may be configured to allow a local router to determine the multicast traffic.

To provide an EDS Card including a local MPEG Layer II decoder to allow stored audio files to be converter to analog audio in real time.

To provide an EDS Card that may be configured as a satellite WAN with minimal effort and external equipment.

To allow a network to deploy a receiver system with, for example, an audio broadcasting capability, and later add additional capability such as Ethernet output, etc., by adding the EDS card of the present invention. This prevents the user from having to replace the receiver, remove the audio card or utilize a separate satellite carrier for the transmission of differing content types.

To provide the ability to distribute faxes between a producer and a number of recipients and preferably to do so without incurring typical telecommunication fax charges.

To allow the faxing capabilities of the receiver system to be coupled to the Ethernet connectivity, storage, and web access of content and configuration information for ease of use.

There are many other objects and advantages of the present invention, and in particular, the preferred embodiments and various alternatives set forth herein. They will become apparent as the specification proceeds. It is to be understood, however, that the scope of the present invention is to be determined by the accompanying claims and not by whether any given embodiment achieves all objects or advantages set forth herein.

### BRIEF DESCRIPTION OF THE DRAWINGS

The applicants' preferred embodiments of the present invention are shown in the accompanying drawings wherein:

FIG. 1 illustrates a block diagram of the EDS card of the present invention;

FIG. 2 illustrates a hardware block diagram of the EDS Card of the present invention;

FIG. 3 further illustrates some of the functionality of the EDS Card of the present invention;

FIG. 4 is a block diagram showing the applicant's preferred uplink configuration utilizing a multiplexer to multiplex the satellite transmission;

FIG. 5 is a block diagram of the applicants' preferred downlink configuration for reception of a multiplexed satellite transmission for distribution onto an associated LAN;

FIG. 6 is a block diagram of the applicants' preferred redundant uplink configuration for clear channel transmission of up to 10 mbps;

FIG. 7 is a block diagram of the applicants' preferred redundant uplink configuration for clear channel transmission of up to 50 mbps;

FIG. 8 is a block diagram of one embodiment of the applicants' preferred satellite transmission system, with an Internet backchannel, in which the applicants' preferred EDS card has been inserted into a slot in a satellite receiver in order to distribute Internet content through the card onto an Ethernet LAN to which the card is connected;

FIG. 9 is a block diagram of an alternative embodiment of the applicants' preferred satellite transmission system for distribution of TCP/IP content onto an intranet with a telecommunications-modem-provided backchannel from the receiver to the head-end of the intranet;

FIG. 10 is a block diagram of a prior art satellite data receiver, separate Internet router, and LAN, as described in the BACKGROUND section above.

FIG. 11 illustrates a flowchart of the present invention employed to distribute data or content, for example, audio advertising, from a centralized origination location to a number of geographically diverse receivers.

FIG. 12 illustrates a system 1200 for providing fax service over a satellite network using the EDS card 100 according to an embodiment of present invention.

FIG. 13 illustrates a wiring diagram 1300 for an affiliate system according to a preferred embodiment of the present invention.

### DETAILED DESCRIPTION OF THE PREFERRED EMBODIMENTS

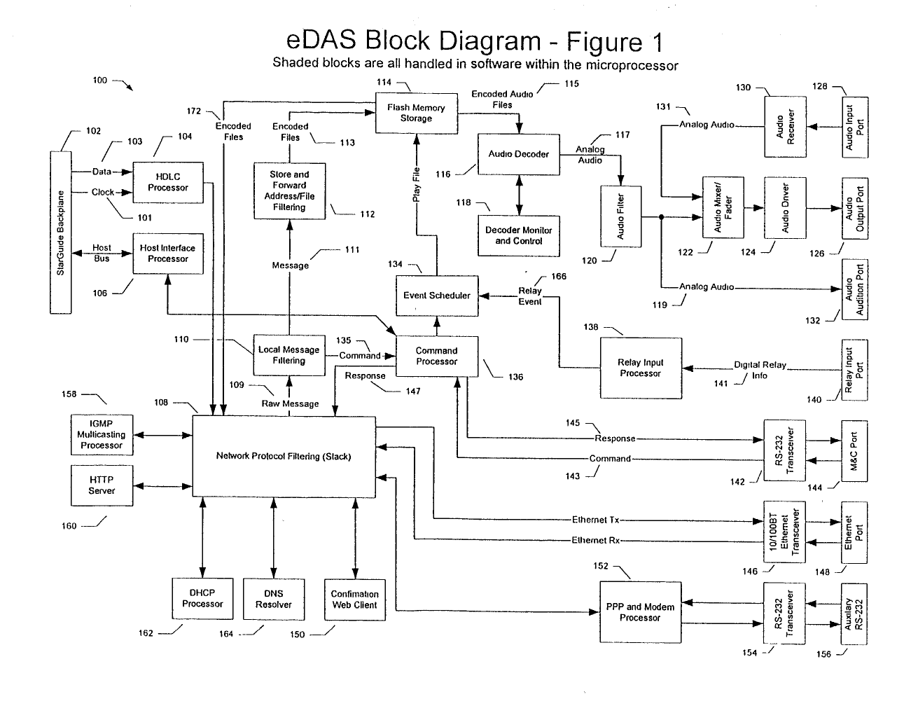

FIG. 1 illustrates a block diagram of the EDS card 100. The EDS card 100 includes a StarGuide backplane 102, an HDLC Processor 104, a host interface processor 106, a Network Protocol Filtering (Stack) processor 108, a local message filtering processor 110, a Store and forward address/file filtering processor 112, a flash memory storage 114, an audio decoder 116, a decoder monitor and control processor 118, an audio filter 120, an audio mixer/fader 122, an audio driver 124, an audio output port 126, an audio input port 128, an audio receiver 130, an audio audition port 132, an event scheduler 134, a relay input processor 138, a relay input port 140, a RS-232 Transceiver 142, and M&C Port 144, a 10/100BT Ethernet Transceiver 146, an Ethernet Port 148, a confirmation web client 150, a PPP and modem processor 152, an RS-232 Transceiver 154, an Auxiliary RS-232 Port 156, an IGMP multicasting processor 158, an HTTP Server 160, a DHCP Processor 162, and a DNS Resolver 164.

In operation, the StarGuide backplane 102 interfaces with a receiver, preferably the prior art StarGuide® II Receiver (not shown), available from StarGuide Digital Networks, Inc., Reno, Nev. The Backplane 102 provides the EDS card 100 with a clock 101 and an HDLC packetized TCP/IP data stream 103. As mentioned above, the TCP/IP data stream may represent, audio, video, text, image or other multimedia information, for example. The clock 101 and the data stream 103 are provided to the HDLC processor 104 which depacketizes the data stream 103 and outputs TCP/IP packets to the network protocol filtering (stack) processor 108. The stack processor 108 may be configured to control the overall function and data allocation of the EDS card 100. The stack processor 108 may send the received data stream to any one of the IGMP multicasting processor 158, the HTTP Server 160, the DHCP Processor 162, the DNS resolver 164, the confirmation web client 150, the 10/100BT Ethernet Transceiver 146, the PPP and modem processor 152 or the local message filtering processor 110 as further described below. The stack processor 108 may be controlled by commands embedded in the data stream, commands sent through the M&C Port 144, commands sent through the Ethernet Port 148, commands through the Host interface processor 106, or commands received through the Auxiliary RS-232 port 156. These commands may be expressed in ASCII format or in the StarGuide Packet Protocol. The commands received by the stack processor 108 via the Ethernet Port 148 may use various interfaces including Simple Network Management Protocol (SNMP), Telnet, Hyper Text Transfer Protocol (HTTP) or other interfaces. The externally receivable operation commands for the stack processor 108 are set forth in APPENDIX A.

The stack processor 108 may further decode a received data stream to send a raw message 109 to the local message filtering processor 10. The local message filtering processor 110 determines if the raw message 109 is a content message such as audio, video, or text, for example, or a command message. The local message filtering processor 110 passes content messages 111 to the Store and forward address/file filtering processor 112 and passes command messages 135 to the command processor 136. The Store and forward address/file filtering processor 112 generates encoded files 113 which are passed to the flash memory storage 114.

The flash memory storage 114 stores the encoded files 113. Encoded files stored in the flash memory storage 114 may be passed to the audio decoder 116 if the encoded files are audio files. Encoded files 172 other than audio files may be passed from the flash memory storage 114 to the stack processor 108 for further transmission. The flash memory storage 114 preferably stores at least up to 256 audio files or “spots”. The flash memory storage 114 preferably uses MUSICAM MPEG Layer II compression with a maximum spot size up to the storage capacity if the file stored is a compressed audio file. Other files, such as compressed video files, may be stored using MPEG2 compression or an alternative compression protocol. The storage capacity of the flash memory storage 114 is preferably at least 8 MB to 144 MB, which is roughly equivalent to 8 to 144 minutes of digital audio storage at 128 kbps MPEG audio encoding. The flash memory storage 114 preferably supports insertion activation with the relay contract closure in absolute time and supports an insertion mode with or without cross-fading.

The audio decoder 116 decodes the encoded files 115 and generates an analog audio signal 117. The audio decoder 116 is monitored by the decoder monitor and control processor 118 while the audio decoder 116 decodes the encoded files 115. The analog audio signal 117 is passed to the audio filter 120 where the analog audio signal 117 is further filtered to increase its audio output quality. The audio decoder 116 includes an MPEG Layer II decoder allowing the pre-encoded stored files from the flash memory storage 114 to be converted to analog audio signals 117 in real time. The analog audio signal is then passed from the audio filter 120 to the audio mixer/fader 122 and the audio audition port 132. The analog audio signal 119 received by the audio audition port 132 may be passed to an external listening device such as audio headphones to monitor the audio signal. The audio audition port 132 of the EDS card allows the locally stored audio to be perceived without altering the output audio feed through the audio output port 126. The audio audition port 132 may be of great use when the audio output port 126 output is forming a live broadcast feed.

An external audio signal may be received by the audio input port 128. The external audio signal is then passed to the audio receiver 130 and the resultant analog audio signal 131 is passed to the audio mixer/fader 122. The audio mixer/fader may mix or fade an external analog audio signal 131 (if any) with the audio signal received from the audio filter 120. The output of the audio mixer/fader is then passed to the audio driver 124 and then to the audio output port 126. Also, the audio input port 128 allows a “live” audio feed to be mixed or faded at the audio mixer/fader 122 with a locally stored audio spot from the flash memory storage 114. The audio mixer/fader allows the live feed and the local (stored) feed to be mixed, cross faded or even amplified. Mixing entails the multiplication of two signals. Cross fading occurs when two signals are present over a single feeds and the amplitude of a first signal is gradually diminished while the amplitude of a second signal is gradually increased. Mixing, amplification, and cross fading are well known to those skilled in the art.

As mentioned above, the flash memory storage 114 may store a large number of audio spot files in addition to files such as video, text or other multimedia, for example. Files stored in the flash memory storage 114 are controlled by the event scheduler 134. The event scheduler 134 may be controlled through the relay input processor 138 of the relay input port 140 or through the command processor 136. The command processor 136 may receive programming including event triggers or command messages through the local message filtering processor 110 and the stack processor 108 from the M&C Port 144, the Auxiliary RS-232 Port 156, the Ethernet Port 148, the received data stream 103, or the Host interface processor 106.

For example, with respect to audio spots stored in the flash memory storage 114, the audio spots may be triggered at a pre-selected or programmed time by the event scheduler 134. The event scheduler 134 may receive audio spot triggers from either the command processor 136 or the relay input processor 138. The command processor 136 may receive programming including event triggers from the M&C Port 144, the Auxiliary RS-232 Port 156, the Ethernet Port 148, the received data stream 103, or the Host interface processor 106. External audio spot triggers may be received directly by the relay input port 140, which passes digital relay info 141 of the audio spot trigger to the relay input processor 138. Additionally, the local message filtering processor 110 may detect a command message in the raw message 109 it receives from the stack processor 108. The command message detected by the local message filtering processor 110 is then passed to the command processor 136. Also, the command processor 136 may be programmed to trigger an event at a certain absolute time. The command processor 136 receives absolute time information from the StarGuide backplane 102.

Additionally, once the command processor 136 receives a command message, the command processor 136 sends a response message to the command originator. For example, when the command processor 136 receives a command message from the M&C Port 144, the command processor 136 sends a response message 145 to the M&C Port 144 via the RS-232 Transceiver 142. Similarly, when a command message is received from the Ethernet Port 148, Auxiliary RS-232 Port 156, or Host interface processor 106, the command processor 136 sends a response message through the stack processor 108 to the command originating port to the command originating device. When a command message is received from the received data stream 103, a response may be sent via one of the other communication ports 148, 156, 106 or no response sent.

In addition to activating audio spots, the event scheduler 134 may trigger the flash memory storage 114 to pass a stored encoded file 172 to the stack processor 108. The encoded file 172 may be audio, video, data, multimedia or virtually any type of file. The stack processor 108 may further route the received encoded file 172 via the Ethernet Port, 148, the Auxiliary RS-232 Port 156, or the M&C Port 144 to an external receiver. Additionally, the stack processor 108 may repackage the received encoded data file 172 into several different formats such as multicast via the IGMP Multicasting Processor 158, or HTTP via the HTTP server 160, telnet, or SNMP for external transmission.

The 10/100BT Ethernet Transceiver 146 receives data from the stack processor 108 and passes the data to the Ethernet Port 148. The 10/100BT Ethernet Transceiver 146 and Ethernet Port 148 may support either 10BT or 100BT Ethernet traffic. The 10/100BT Ethernet Transceiver 146 uses an auto-negotiating 10/100BT interface so that the EDS card 100 may easily integrate into an existing 10BT or 100BT LAN. In addition to supplying data to an existing 10BT or 100BT LAN via the Ethernet Port 148, the stack processor 108 may receive data from an external network via the Ethernet Port 148. External data passes from the Ethernet Port 148 through the 10/100BT Ethernet Transceiver 146 to the stack processor 108. The external data may constitute command messages or audio or video data for example.

The EDS card 100 also includes a PPP and modem processor 152. The PPP and modem processor may be used for bi-directional communication between the stack processor 108 and the Auxiliary RS-232 Port 156. The PPP and modem processor 152 reformats the data for modem communication and then passes the data to the RS-232 Transceiver 154 of the Auxiliary RS-232 Port 156 for communication to an external receiving modem (not shown). Data may also be passed from an external modem to the stack processor 108. The PPP and modem processor 152 allows the EDS card 100 to communicate with an external modem so that the EDS card may participate in a distribution network via standard telecommunications lines, for example. The PPP and modem processor 152 may be used for distribution as well as automatic affidavit and confirmation tasks.

The EDS card 100 also includes an Internet Group Multicasting Protocol (IGMP) Multicasting Processor 158 receiving data from and passing data to the stack processor 108. The IGMP multicasting processor 158 may communicate through the stack processor 108 and the Ethernet Port 148 or the Auxiliary RS-232 Port 156 with an external network such as a LAN. The IGMP multicasting processor 158 may be programmed to operate for multicasting using IGMP pruning, a protocol known in the art, for multicasting without using IGMP Pruning (static router) and for Unicast routing.

When the IGMP multicasting processor 158 is operated using the IGMP pruning, the IGMP multicasting processor 158 may be either an IGMP querier or a non-querier. When the IGMP multicasting processor 158 is operated as a querier, the IGMP multicasting processor 158 periodically emits IGMP queries to determine if a user desires multicasting traffic that the EDS Card 100 is currently receiving. If a user desired multicasting traffic, the user responds to the IGMP multicasting processor 158 and the IGMP multicasting processor 158 transmits the multicast transmission through the stack processor 108 to an external LAN. The IGMP multicasting processor 138 continues emitting IGMP queries while transmitting the multicast transmission to the external user and the external user continues responding while the external user desires the multicast transmission. When the user no longer desires the multicast transmission, the user ceases to respond to the IGMP queries or the user issues an IGMP “leave” message. The IGMP multicasting processor detects the failure of the user to respond and ceases transmitting the multicast transmission.

Under the IGMP Protocol, only one IGMP querier may exist on a network at a given time. Thus, if, for example, the network connected to the Ethernet Port 148 already has an IGMP enabled router or switch, the IGMP multicasting processor 158 may be programmed to act as a non-querier. When the IGMP multicasting processor 158 acts as a non-querier, the IGMP multicasting processor manages and routes the multicasting traffic, but is not the querier and thus does not emit queries. The IGMP multicasting processor 138 instead responds to commands from an external router.

When the IGMP multicasting processor 158 performs multicasting without using IGMP pruning, the IGMP multicasting processor 158 acts as a static router. The IGMP multicasting processor 158 does not use IGMP and instead uses a static route table that may be programmed in one of three ways. First, the IGMP multicasting processor 158 may be programmed to merely pass though all multicast traffic through the stack processor 108 to an external LAN. Second, the IGMP multicasting processor 158 may be programmed to pass no multicast traffic. Third, the IGMP multicasting processor 158 may be programmed with a static route table having individual destination IP address or ranges of destination IP addresses. Only when the IGMP multicasting processor 158 receives multicast traffic destined for an IP address in the static route table, the multicast traffic is passed to the external LAN.

When the IGMP multicasting processor 158 performs Unicast routing, the IGMP multicasting processor 158 acts as a static router wherein received traffic in not multicast and is instead delivered only to a single destination address. As when performing multicast routing without IGMP pruning, the IGMP Multicast Processor 158 uses a static route table and may be programmed in one of three ways. First, to merely pass through received traffic to its individual destination address. Second, to pass no Unicast traffic. Third, the IGMP multicasting processor 158 may be programmed with a static route table having individual destination IP addresses and the IGMP multicasting processor 158 may pass traffic only to one of the individual destination IP addresses.

The IGMP multicasting processor 158 may be programmed via the M&C Port 144, the Ethernet Port 148, the Auxiliary RS-232 Port 156, the Host interface processor 106 or the received data stream 103. Additionally, the IGMP multicasting processor 158 may multicast via the Auxiliary RS-232 Port 156 in addition to the Ethernet Port 148.

The EDS card 100 also includes an HTTP Server 160 (also referred to as a Web Server). The HTTP Server 160 receives data from and passes data to the stack processor 108. Data may be retrieved from the HTTP Server 160 by an external device through either a LAN communicating with the Ethernet Port 148 or a modem communicating with the Auxiliary RS-232 Port 156. Either the modem or the LAN may transmit an HTTP data request command to the stack processor 108 via their respective communication channels, (i.e., the PPP and modem processor 152 and the 10/100BT Ethernet Transceiver respectively). The stack processor 108 transmits the received data request command to the HTTP Server 160 which formats and transmits a response to the stack processor 108 which transmits the response back along the appropriate channel to the requestor.

Preferably, the HTTP Server 160 may be used to allow the EDS Card 100 to be configured and monitored via a standard Web Browser accessible through both the Ethernet Port 148 or the Auxiliary RS-232 port. Additionally, the HTTP Server 160 allows a web browser access to the files stored in the flash memory storage 114. Files may be downloaded for remote play, may be modified and up loaded, or may be played through the web browser. Additionally, the event scheduler 134 may be controlled with a web browser via the HTTP Server 160. The HTTP Server 160 allows complete remote access to the functionality of the EDS Card 114 and the contents of the flash memory storage 114 through a convenient web browser. Additionally, the HTTP Server 160 allows new files to be uploaded to the flash memory storage 114 via a convenient web browser. Use of the HTTP Server 160 in conjunction with a web browser may be the preferred way of monitoring the function and content of the EDS Card 100 remotely.

The EDS card 100 also includes a DHCP Processor 162 receiving data from and passing data to the stack processor 108. The DHCP Processor 162 provides Dynamic Host Configuration Protocol services for the EDS card 100. That is, the DHCP Processor allows the EDS card's 100 IP address to be automatically configured on an existing LAN supporting DHCP. The DHCP Processor thus eliminates the need to manually configure the EDS card's 100 IP address when the EDS card 100 is operated as part of a LAN supporting DHCP. In operation, the DHCP Processor 162 communicates with an external LAN via the Ethernet Port 148. IP data is passed from the external LAN through the Ethernet Port 148 and 10/100BT Ethernet Transceiver 146 and the stack processor 108 to the DHCP Processor 162 where the IP data is resolved and the dynamic IP address for the EDS card 100 is determined. The EDS card's 100 IP address is then transmitted to the external LAN via the stack processor 108, 10/100BT Ethernet Transceiver 146 and Ethernet Port 148. Additionally, the DHCP Processor 163 determines if the external LAN has a local DNS server. When the external LAN has a local DNS server the DHCP Processor 163 queries the local DNS server for DNS addressing instead of directly quering an Internet DNS server. Also, the DHCP Processor 162 allows the IP address for the EDS Card 100 to be dynamically reconfigured on an existing LAN supporting DHCP.

The EDS card 100 also includes a DNS Resolver 164 receiving data from and passing data to the stack processor 108. The DNS Resolver 164 provides Domain Name Service to the EDS card 100 to allow the EDS card to dynamically communicate with external host web servers regardless of the web server IP address. In operation, the DNS Resolver 164 communicates with an external host web server via the stack processor 108 and either the Ethernet Port 148 or the Auxiliary RS-232 Port 156. The DNS Resolver 164 receives IP address information from the external host web server and resolves mnemonic computer addresses into numeric IP addresses and vice versa. The resolved IP address information is then communicated to the stack processor 108 and may be used as destination addressing for the external host web server.

The EDS Card 100 also includes a confirmation web client 150 receiving data from and passing data to the stack processor 108. When a data file, such as an audio file, is received by the EDS Card 100, the confirmation web client 150 confirms that the EDS Card 100 received the data by communicating with an external server preferably an HTTP enabled server such as the StarGuide® server. The confirmation web client's 150 confirmation data may be transmitted via either the Ethernet Port 148, the Auxiliary Port 156 or both. Additionally, once a file, such as an audio spot is played or otherwise resolved, the confirmation web client 150 may also send a confirmation to an external server preferably an HTTP enabled server such as the StarGuide® server. The confirmation web client's 150 confirmation may be then be easily accessed via web browser from the HTTP enabled server.

The flash memory storage 114 operates in conjunction with the event scheduler 134 and the command processor 136 to provide audio insertion capability and support for manual and automatic sport insertion, external playback control via the relay input port 140, Cross-Fade via the audio mixer/fader 122 and spot localization. The command processor 136 also maintains a built-in log of audio spots played. The built-in log may be retrieved through the M&C Port 144, the Ethernet Port 148, or the Auxiliary RS-232 Port 156. The built-in log may assist affidavit collection for royalty or advertising revenue determination, for example.

The Host interface processor 106 receives data from and transmits data to the StarGuide backplane 102. The Host interface processor 106 allows the EDS Card 100 to be controlled via the front panel (not shown) of the receiver in which the EDS Card 100 is mounted. The Host interface processor 106 retrieves from the command processor 136 the current operating parameters of the EDS Card 100 for display on the front panel of the receiver. Various controls on the front panel of the receiver allow users to access locally stored menus of operating parameters for the EDS Card 100 and to modify the parameters. The parameter modifications are received by the Host Processor 106 and then transmitted to the command processor 136. The Host interface processor 106 also contains a set of initial operating parameters and interfaces for the EDS Card 100 to support plug-and-play setup of the EDS Card 100 within the receiver.

As described above, the EDS card 100 includes many useful features such as the following. The EDS card 100 includes the audio input port 128 to allow a “live” audio feed to be mixed or faded at the audio mixer/fader 122 with a locally stored audio spot from the flash memory storage 114. Also, the audio mixer/fader allows the live feed and the local (stored) feed to be mixed, cross faded or even amplified. Additionally, the EDS card's 100 relay input port 140 allows external triggering of the EDS card including audio event scheduling. Also, the event scheduler 134 allows the EDS card to play audio files at a predetermined time or when an external triggering event occurs. Additionally, the audio decoder 116 includes an MPEG Layer II decoder allowing the pre-encoded stored files from the flash memory storage 114 to be converted to analog audio signals 117 in real time. Also, the audio audition port 132 of the EDS card allows the locally stored audio to be perceived without altering the output audios feed through the audio output port 126. The audio audition port 132 may be of great use when the audio output port 126 output is forming a live broadcast feed.

The features of the EDS card 100 also include the ability to receive files from a head end distribution system (such as ExpressNet) based on the EDS card's unique stored internal address. Once the EDS Card 100 receives an ExpressNet digital package, the EDS Card 100 may send a confirmation via the Ethernet Port 148 or the Auxiliary RS-232 port 156 to the package originator. Also, the IGMP multicasting processor 158 of the EDS card 100 provides locally configured static routing which allows certain IP addresses to be routed from a satellite interface through the EDS card 100 directly to the Ethernet Port 148. Also, the EDS Card 100 supports a variety of communication interfaces including HTTP, telnet, and SNMP to allow configuration and control of the EDS Card 100 as well as downloading, uploading, and manipulation of files stored on the flash memory storage 114.

Additionally, because the traffic received by the EDS Card 100 is HDLC encapsulated, the traffic received by the EDS Card 100 appears as if it is merely arriving from a transmitting router and the intervening satellite uplink/downlink is transparent. Because of the transparency, the EDS Card 100 may be configured as a satellite Wide Area Network WAN with minimal effort and additional equipment.

In general, the EDS Card 100 is an extremely flexible file storage and transmission tool. The EDS Card 100 may be programmed through the Host interface processor 106, the M&C Port 144, the Auxiliary RS-232 Port 156, the received data stream 103, and the Ethernet Port 148. It may be preferable to program the EDS Card 100 through the Host interface processor 106 when programming from the physical location of the EDS card 100. Alternatively, when programming the EDS Card 100 remotely, it may be preferable to program the EDS Card 100 via the Ethernet Port 148 because the Ethernet Port 148 supports a much higher speed connection.

In addition, files such as audio, video, text, and other multimedia information may be received by the EDS card 100 through the received data stream 103, the M&C Port 144, the Auxiliary RS-232 Port 156, and the Ethernet Port 148. Preferably, files are transmitted via the received data stream 103 or the Ethernet Port 148 because the received data stream 103 and the Ethernet Port 148 support a much higher speed connection. Also, files such as audio, video, text and other multimedia information may be transmitted by the EDS card 100 through the M&C Port 144, the Auxiliary RS-232 Port 156, and the Ethernet Port 148. Preferably, files are transmitted via the Ethernet Port 148 because the Ethernet Port 148 supports a much higher speed connection. Audio files may also be transmitted via the audio output port 126 in analog form.

Additionally, the EDS Card 100 may perform time-shifting of a received data stream 103. The received data stream 103 may be stored in the flash memory storage 114 for later playback. For example, an audio broadcast lasting three hours may be scheduled to begin at 9 am, New York time in New York and then be scheduled to begin an hour later at 7 am. Los Angeles time in Los Angeles. The received data stream 103 constituting the audio broadcast may be received by an EDS Card in California and stored. After the first hour is stored on the California EDS Card, playback begins in California. The EDS card continues to queue the received audio broadcast by storing the audio broadcast in the flash memory storage while simultaneously triggering, via the event scheduler 134, the broadcast received an hour ago to be passed to the audio decoder and played.

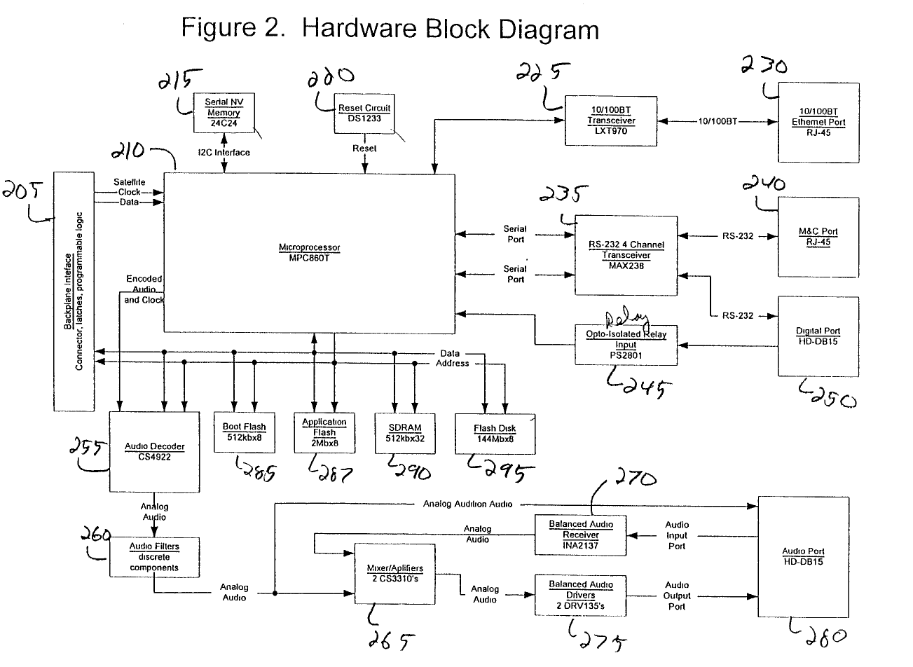

FIG. 2 illustrates a hardware block diagram of the EDS Card 200. The EDS Card 200 includes a Backplane Interface 210, a Microprocessor 210, a Serial NV Memory 215, a Reset Circuit 220, a 10/100BT Transceiver 225, a 10/100BT Ethernet Port 230, a RS-232 4 Channel Transceiver 235, a M&C Port 240, an Opto-Isolated Relay Input 245, a Digital Port 250, an audio decoder 255, and audio filter 260, a Mixer/Amplifier 265, a Balanced Audio Receier 270, a Balanced audio driver 275, an Audio Port 280, a Boot Flash, 285, an Application Flash 287, an SDRAM 90, and a Flash Disk 295.

In operation, the Backplane Interface 205 performs as the StarGuide backplane 102 of FIG. 1. The Microprocessor 210 includes the HDLC Processor 104, the Host interface processor 106, the stack processor 108, the local message filtering processor 110, the Store and forward address/file filtering processor 112, the event scheduler 134, the command processor 136, the decoder monitor and control processor 118, the relay input processor 138, the confirmation web client 150, the PPP and modem processor 152, the IGMP multicasting processor 158, the HTTP Server 160, the DHCP Processor 162, and the DNS Resolver 164, as indicated by the shaded elements of FIG. 1. The Serial NV Memory 215 stores the initial command configuration used at power-up by the command processor 136. The Reset Circuit 220 ensures a controlled power-up. The 10/100BT Transceiver performs as the 10/100BT Ethernet transceiver 146 of FIG. 1 and the 10/100BT Ethernet Port 230 performs as the Ethernet Port 148 of FIG. 1. The RS-232 4 Channel Transceiver 235 performs as both the RS-232 Transceiver 142 and the RS-232 Transceiver 154 of FIG. 1. The Digital Port 250 in conjunction with the RS-232 Channel Transceiver 235 performs as the Auxiliary RS-232 Port 156 of FIG. 1. The M&C Port 240 performs as the M&C Port 144 of FIG. 1. The Opto-Isolated Relay Input 245 and the Digital Port 250 perform as the relay input port 140. The audio decoder 255, audio filters 260, Mixer/Amplifiers 265, Balanced audio receiver 270, Balanced audio drivers 275 and Audio Port 280 perform as the audio decoder 116, audio filter 120, audio mixer/fader 122, audio receiver 130, audio driver 124, and audio output port 126 respectively of FIG. 1. The Flash Disk 295 performs as the flash memory storage 114 of FIG. 1.

The Boot Flash 285, Application Flash 287, and SDRAM 290 are used in the start-up and operation of the EDS Card 100. The Boot Flash 285 holds the initial boot-up code for the microprocessor operation. When the Reset Circuit 220 is activated, the Microprocessor 210 reads the code from the Boot Flash 285 and then performs a verification of the Application Flash 287. The Application Flash 287 holds the application code to run the microprocessor. Once the Microprocessor 210 has verified the Application Flash 287, the application code is loaded into the SDRAM 290 for use by the microprocessor 210. The SDRAM 290 holds the application code during operation of the EDS Card 100 as well as various other parameters such as the static routing table for use with the IGMP Multicasting Microprocessor 158 of FIG. 1.

The microprocessor 210 is preferably the MPC860T microprocessor available from Motorola, Inc. The Reset Circuit 220 is preferably the DS1233 available from Dallas Semiconductor, Inc. The 10/100BT Ethernet Transceiver 225 is preferably the LXT970 available from Level One, Inc. The audio decoder 255 and the Mixer Amplifier 265 are preferably the CS4922 and CS3310 respectively, available from Crystal Semiconductor, Inc. The Flash Disk 295 is preferably a 144Mbx8 available from M-Systems, Inc. The remaining components may be commercially obtained from a variety of vendors.

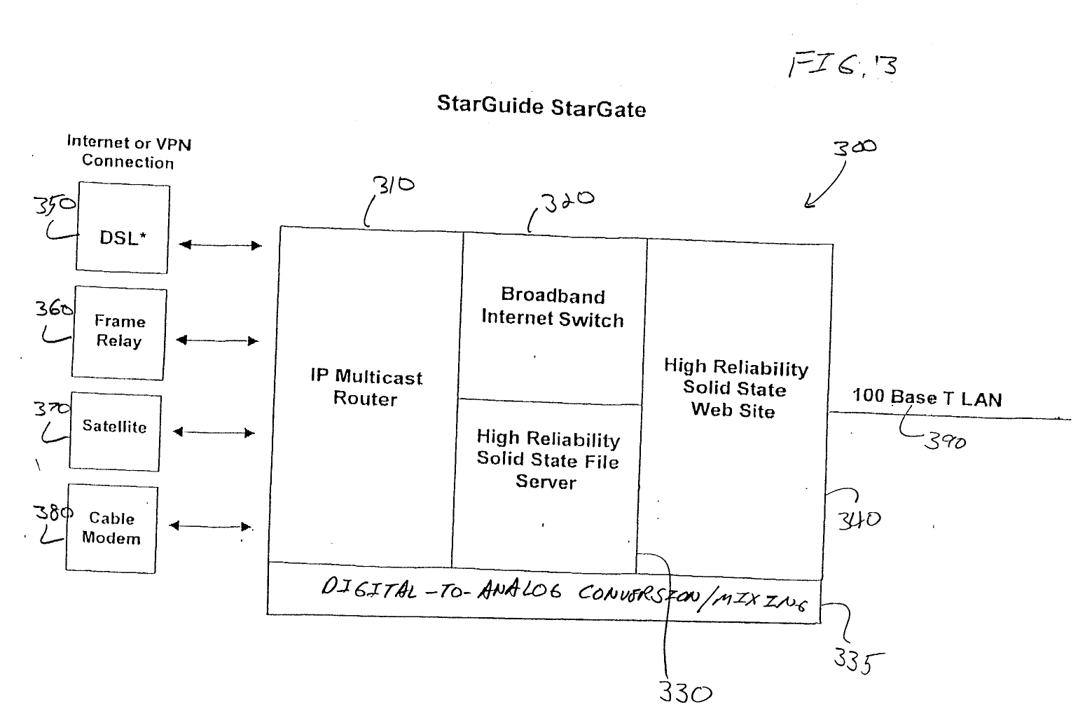

FIG. 3 further illustrates some of the functionality of the EDS Card 300 of a preferred embodiment of the present invention. Functionally, the EDS card 300 includes an IP Multicast Router 310, a Broadband Internet Switch 320, a High Reliability Solid State File Server 330, and a High Reliability Solid State Web Site 340. The EDS card 300 may receive data from any of a number of Internet or Virtual Private Network (VPN) sources including DSL 350, Frame Relay 360, Satellite 370, or Cable Modem 380. The EDS card 300 may provide data locally, such as audio data, or may transmit received data to a remote location via an Ethernet link such as a 100 Base T LAN link 390 or via DSL 350, Frame Relay 360, Satellite 370, or Cable Modem 380. Data received by the EDS Card 300 may be routed by the IP Multicast Router 310, may be switched through the Broadband Internet Switch 320, or may be stored on the High Reliability Solid State File Server 330. The EDS card may be monitored and controlled via the High Reliability Solid State Website 340, which may be accessed via the 100 Base T LAN link 390, DSL 350, Frame Relay 360, Satellite 370, or Cable Modem 380.

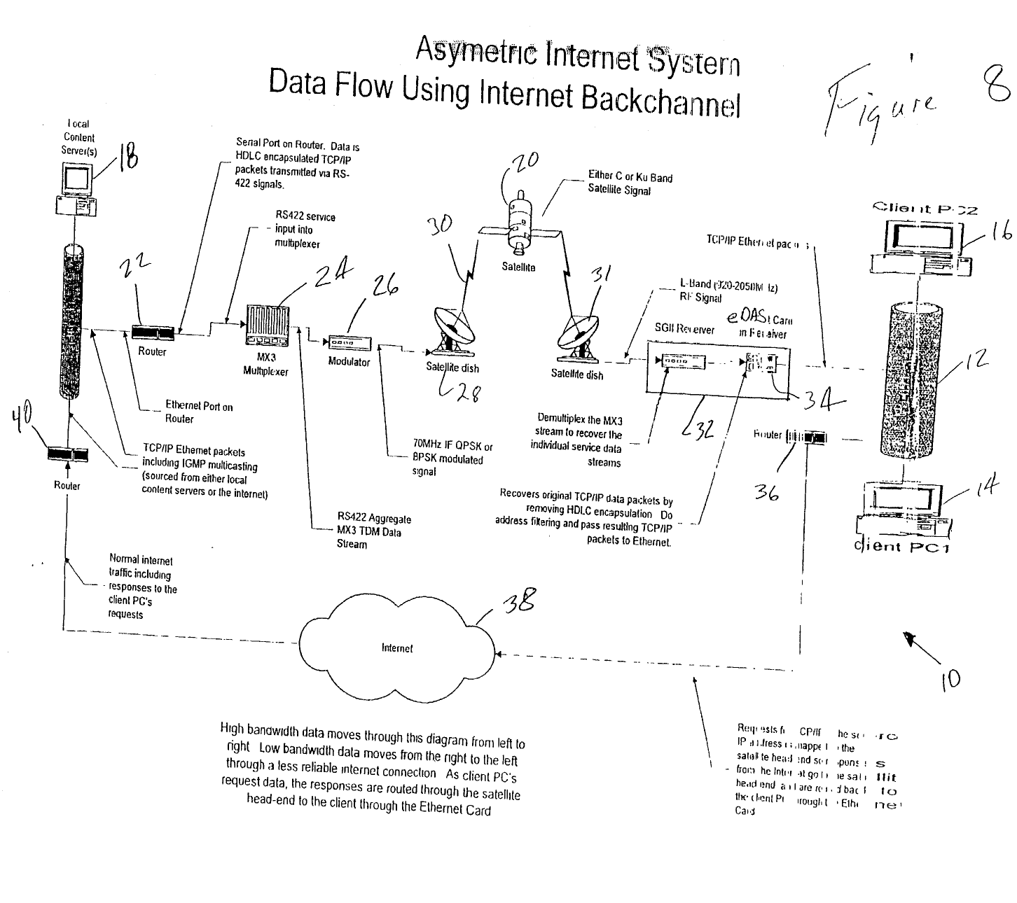

Referring now to FIG. 8, the applicants' preferred Internet backchannel system 10 is preferably utilized to distribute Internet content (according to the TCP/IP protocol, which may include UDP packets) onto a remote LAN 12 interconnecting PC's, e.g., 14, 16, on the remote LAN 12. Through the applicants' preferred Internet satellite transmission system 10, content residing on a content server PC 18 is distributed according to the TCP/IP protocol through a third-party satellite 20 to the client PC's 14, 16 on the remote Ethernet LAN 12.

In the applicants' preferred system 10, the TCP/IP content flow is as follows:

1. A PC, e.g., 14, on the remote Ethernet LAN 12 is connected to the Internet through a conventional, and typically pre-existing, TCP/IP router 36 in a fashion well known to those skilled in the art. The router 36 can thus send requests for information or Internet content through the Internet 38 to a local router 40 to which a content server 18 (perhaps an Internet web server) is connected in a fashion well known to those skilled in the art.

2. The content server 18 outputs the Internet content in TCP/IP Ethernet packets for reception at the serial port (not shown) on a conventional Internet router 22;

3. The router 22 outputs HDLC encapsulated TCP/IP packets transmitted via RS422 signals at an RS-422 output port (not shown) into an RS-422 service input into a StarGuide(R) MX3 Multiplexer 24, available from StarGuide Digital Networks, Inc., Reno, Nev. (All further references to StarGuide® equipment refer to the same company as the manufacturer and source of the equipment.) The method of multiplexing utilized by the MX3 Multiplexer is disclosed in Australia Patent No. 697851, issued on Jan. 28, 1999, to StarGuide Digital Networks, Inc, and entitled—Dynamic Allocation of Bandwidth for Transmission of an Audio Signal with a Video Signal.”

4. The StarGuide® MX3 Multiplexer 24 aggregates all service inputs into the Multiplexer 24 and outputs a multiplexed TDM (time division multiplexed) data stream through an RS-422 port (not shown) for delivery of the data stream to a modulator 26, such as a Comstream CM701 or Radyne DVB3030, in a manner well known to those skilled in the art. The modulator 26 supports DVB coding (concatenated Viterbi rate N/(N+I) and Reed-Solomon 187/204, QPSK modulation, and RS-422 data output). Multiple LANs (not shown) may also be input to the StarGuideg Multiplexer 24 as different services, each connected to a different service input port on the StarGuideg Multiplexer 24,

5. The modulator 26 outputs a 70 MHz RF QPSK or BPSK modulated signal to a satellite uplink and dish antenna 28, which transmits the modulated signal 30 through the satellite 20 to a satellite downlink and dish antenna 31 remote from the uplink 28.

6. The satellite downlink 31 delivers an L-Band (920-2050 MHz) radio frequency (RF) signal through a conventional satellite downlink downconverter to a StarGuide® II Satellite Receiver 32 with the applicants' preferred Ethernet/Router card 34 removably inserted into one of possibly five available insertion card slots (not shown) in the back side of the StarGuide® II Receiver 32. The StarGuide® II Receiver 32 demodulates and demultiplexes the received transmission, and thus recovers individual service data streams for use by the cards, e.g., EDS Card 34, mounted in the StarGuide® II Receiver 32. The Receiver 32 may also have one or more StarGuide® cards including audio card(s), video card(s), relay card(s), or async card(s) inserted in the other four available slots of the Receiver 32 in order to provide services such as audio, video, relay closure data, or asynchronous data streams for other uses or applications of the single receiver 32 while still functioning as a satellite receiver/router as set forth in this specification. For example, other services, available from StarGuide Digital Networks, Inc. of Reno, Nev. that may be added to a receiver include an Asynchronous Services Statistical Demux Interface Module, a Digital Video Decoder Module, an MX3 Digital Multimedia Mulitplexer, a Digital Audio Storage Module, and a Digital Multimedia Satellite Receiver.

7. The EDS Card 34 receives its data and clock from the StarGuide® II Receiver 34, then removes the HDLC encapsulation in the service stream provided to the EDS Card 34 by the StarGuide® II Receiver 32, and thus recovers the original TCP/IP packets in the data stream received from the Receiver 32 (without having to reconstruct the packets). The EDS Card 34 may then, for example, perform address filtering and route the resulting TCP/IP packets out the Ethernet port on the side of the card (facing outwardly from the back of the StarGuide® II Receiver) for connection to an Ethernet LAN for delivery of the TCP/IP packets to addressed PCs, e.g., 14, 16 if addressed, on the LAN in a fashion well to those skilled in the art. Alternatively, as discussed above, the EDS Card 34 may store the received packets on the flash memory storage 114 of FIG. 1 for example.

As a result, high bandwidth data can quickly move through the preferred satellite system 10 from the content server 18 through the one-way satellite connection 20 to the receiving PC, e.g., 14. Low bandwidth data, such as Internet user requests for web pages, audio, video, etc., may be sent from the remote receiving PC, e.g., 14, through the inherently problematic but established Internet infrastructure 38, to the content server 18. Thus, as client PC's, e.g., 14, 16, request data, the preferred system 10 automatically routes the requested data (provided by the content server 12) through the more reliable, higher bandwidth, and more secure (if desired) satellite 20 transmission system to the StarGuide® II Receiver and its associated EDS Card 34 for distribution to the PC's 14, 16 without going through the Internet 38 backbone or other infrastructure.

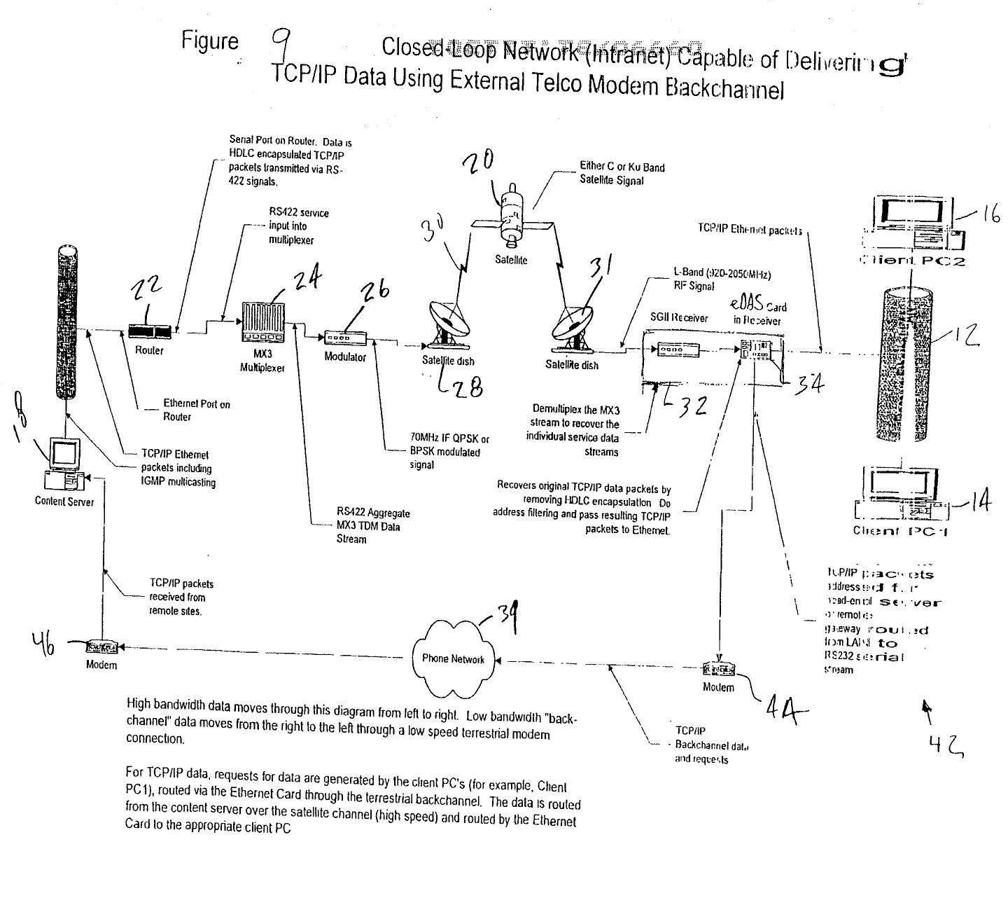

Referring now to FIG. 9, the applicants' preferred intranet system 42 is preferably utilized to distribute TCP/IP formatted content onto a remote LAN 12 interconnecting PC's, e.g., 14, 16, on the remote LAN 12. Through the intranet system 42, content residing on a content server PC 18 is distributed through the intranet 42 to the client PC's 14, 16 through a private telecommunications network 39.

The intranet system 42 of FIG. 9 works similarly to the Internet system 10 of FIG. 1 except that the intranet system 42 does not provide a backchannel through the Internet 40 and instead relies on conventional telecommunications connections, through conventional modems 44, 46, to provide the backchannel. In the applicants' preferred embodiment the remote LAN modem 44 connects directly to an RS-11 port on the outwardly facing side of EDS Card 34 on the back side of the StarGuide® II Receiver 32 in which the EDS Card 34 is mounted. The Ethernet/Router card 34 routes TCP/IP packets addressed to the head end or content server 18 (or perhaps other machines on the local LAN 19) to an RS232 serial output (113 in FIG. 8) to the remote LAN modem 44 for delivery to the content servers or head end 18. Alternatively, the remote modem 44 may be connected to accept and transmit the TCP/IP data and requests from a client PC, e.g., 14, through a router (not shown) on the remote LAN 12, in a manner well known to those skilled in the art.

The local modem 46 is connected to the content server 18 or to a head-end LAN on which the server 18 resides. The two modems 44. 46 thus provide a TCP/IP backchannel to transfer TCP/IP data and requests from PC's 14, 16 on the remote LAN (which could also be a WAN) 12 to the content server 18.

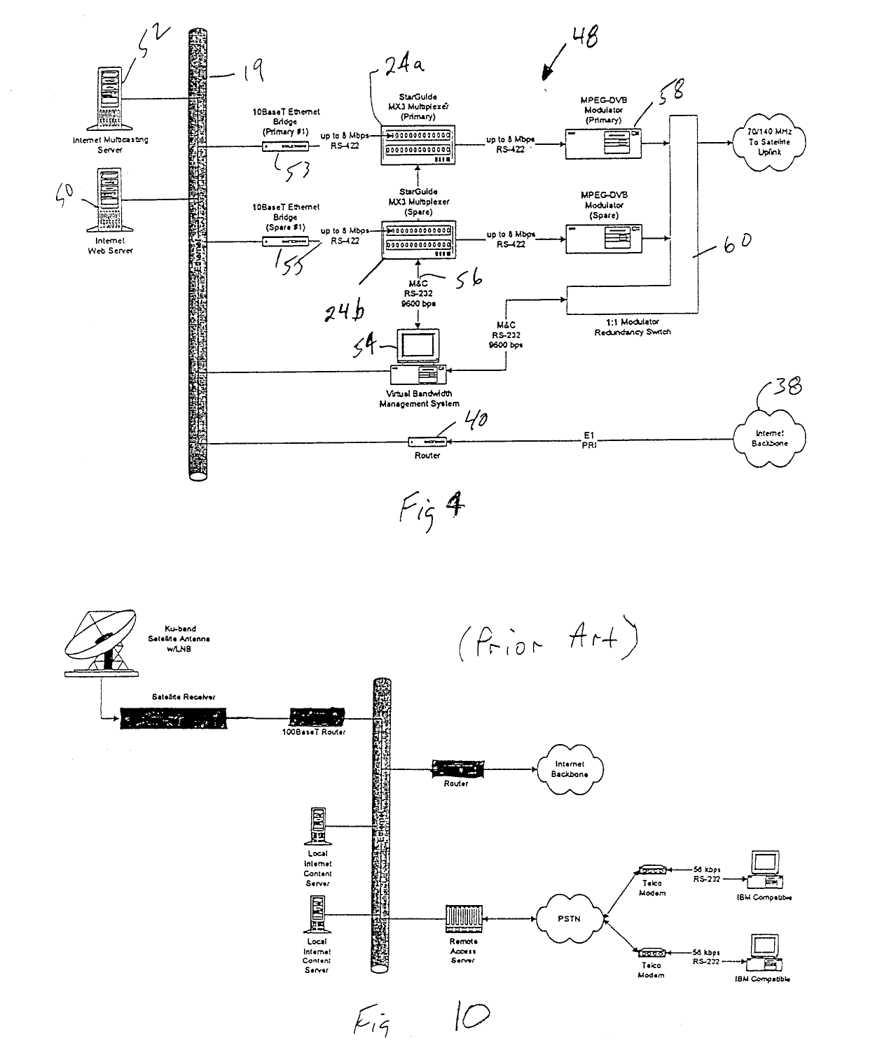

Referring now to FIG. 4, the applicants' preferred “muxed” uplink system, generally 48, is redundantly configured. The muxed system 48 is connected to a local or head-end Ethernet LAN 19, to which an Internet Web Server 50 and Internet Multicasting Server 52 are connected in a manner well known to those of skill in the art. Two 10BaseT Ethernet Bridges 53, 55 provide up to 8 mbps (megabits per second) of Ethernet TCP/IP data into RS422 service ports (not shown) mounted in each of two StarGuide® II MX3 Multiplexers 24a, 24b, respectively. The main StarGuide® Multiplexer 24a is connected via its monitor and control (M&C) ports (not shown) through the spare Multiplexer 24b to a 9600 bps RS-232 link 56 to a network management PC 54 running the Starguide Virtual Bandwidth Network Management System (VBNMS).

Each of the Multiplexers, e.g., 24a, output up to 8 mbps through an RS422 port and compatible connection to an MPEG-DVB modulator, e.g., 58. The modulators, e.g., 58, in turn feed their modulated output to a 1:1 modulator redundancy switch 60 and deliver a modulated RF signal at 70 to 140 MHz for transmission through the satellite (20 in FIG. 8). In this regard, the VBNMS running on the network management PC 54 is also connected to the redundancy switch 60 via an M&C RS-232 port (not shown) on the redundancy switch 60.

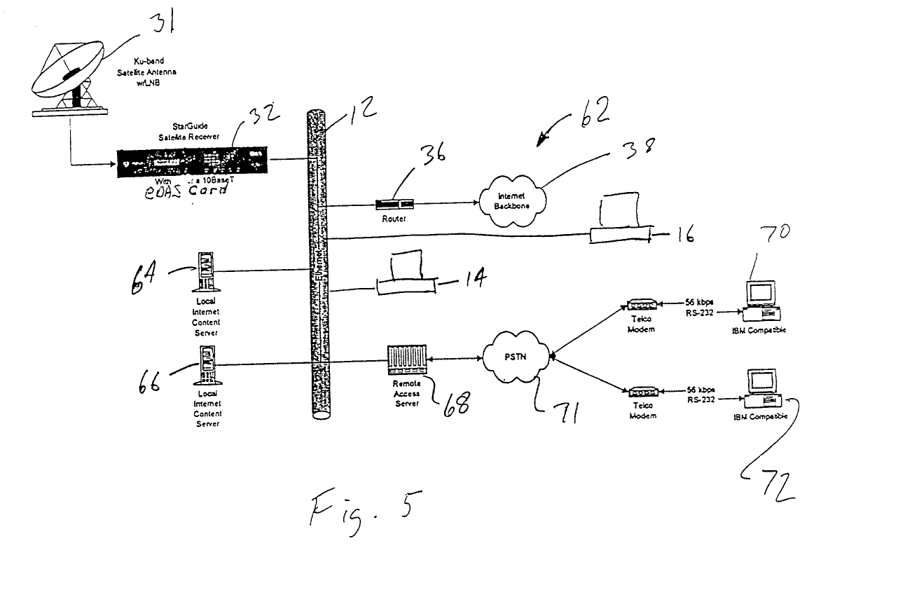

With reference now to FIG. 5, in the applicants' preferred muxed down-link 62, generally, there is no need for a router between the StarGuide® II Satellite Receiver 32 and the remote LAN 12. The Receiver 32 directly outputs the Ethernet encapsulated TCP/IP packets from the Ethernet output port (not shown) on the Receiver 32 onto the LAN cabling 12 with no intermediary hardware at all other than standard in inexpensive cabling hardware.

The LAN 12 may also be connected to traditional LAN and WAN components, such as local content servers 64, 66, router(s), e.g., 36, and remote access server(s), e.g., 68, in addition to the LAN-based PC's, e.g., 14, 16. In this WAN configuration., yet additional remotely connected PC's 70, 72, may dial-in or be accessed on conventional telecommunications lines, such as POTS lines through a public switching teclo network (PTSN) 71 to procure TCP/IP or other content acquired by the remote access server 68, including TCP/IP content delivered to access server 68 according to addressing to a remotely connected PC, e.g., 70, of packets in the Ethernet data stream output of the Ethernet/Router card (34 in FIG. 8).

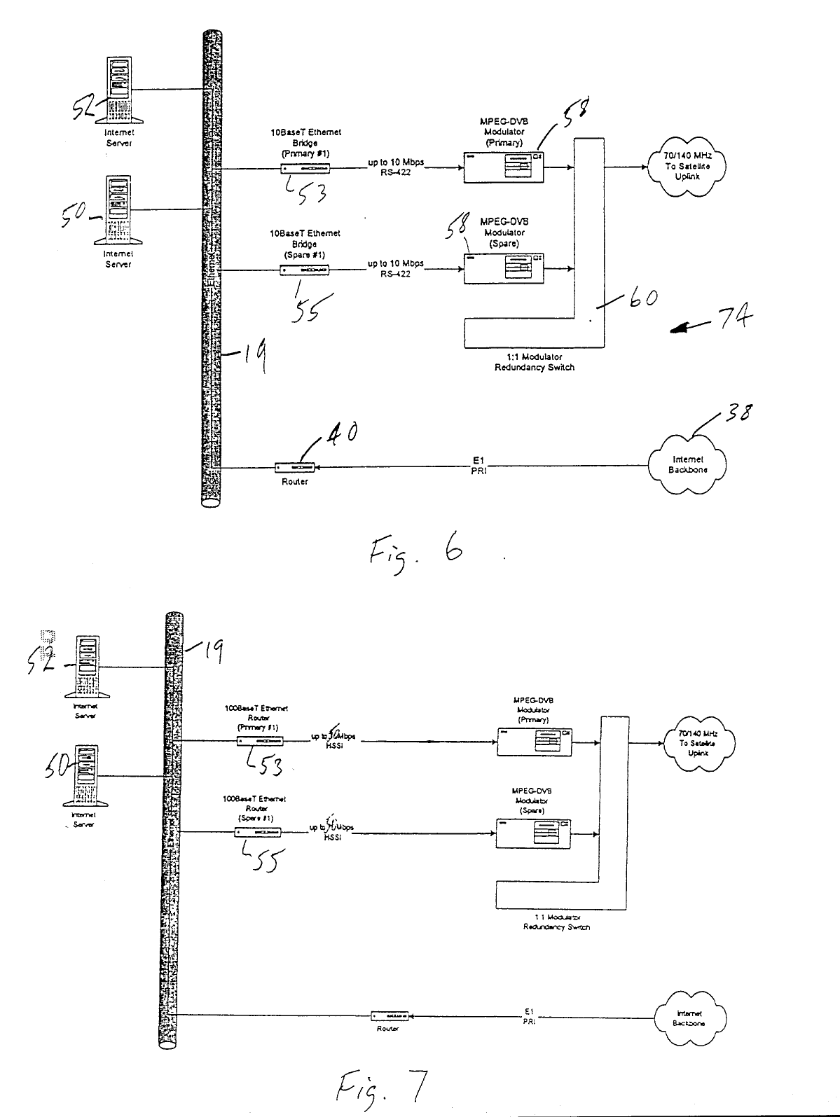

With reference now to FIG. 6, the applicants' preferred clear channel system. Generally 74, eliminates the need for both costly multiplexers (e.g., 24 in FIG. 4) and the VBNMS and associated PC (54 of FIG. 4). The clear channel system 74 is well suited to applications not requiring delivery of multiple services through the system 74. The clear channel system 74 of FIG. 6 provides up to 10 mbps of Ethernet TCP/IP data directly into the input of an MPEG-DVB modulator, e.g., 58, for uplinking of the frequency modulated data for broadcast through the satellite (20 in FIG. 8). (Note that, although these systems employ MPEG-DVB modulators, they do not utilize DVB multiplexers or DVB encrypting schemes.)

Alternatively and with reference now to FIG. 7, the bridges 53, 55 may each instead consist of a 100BaseT Ethernet router 53, 55. As a result, these routers 53, 55 preferably may deliver up to 50 mbps HSSI output′ directly into their respective modulators, e.g., 58. Applicants' preferred modulator for this application is a Radyne DM-45 available from Radyne Corporation.

The preferred receiver/router eliminates the need for any special or custom software while providing a powerful, reliable, and flexible system for high speed. asymmetrical distribution of Internet or TCP/IP compatible content, including bandwidth intensive audio, video, or multimedia content to an Ethernet computer network. This is particularly useful where a digital terrestrial infrastructure is lacking, overburdened, otherwise inadequate, or cost prohibitive.

Although in the above detailed description, the applicants preferred embodiments include Internet or telecommunications backchannels, the above system may utilized to provide high speed audio or video multicasting (via UDP packets and deletion of the backchannel). In this utilization of the applicant's receiver/router in a one-way system from the uplink to the receiver/router, all remote LAN's or other connected computers receive the same data broadcast without any interference to the broadcast such as would be encountered if it were to be sent through the Internet backbone.

Additionally, the EDS Card may be preferably utilized in conjunction with a Transportal 2000 Store-and-Forward System or the StarGuide III Receiver available from StarGuide Digital Networks, Inc., of Reno, Nev.

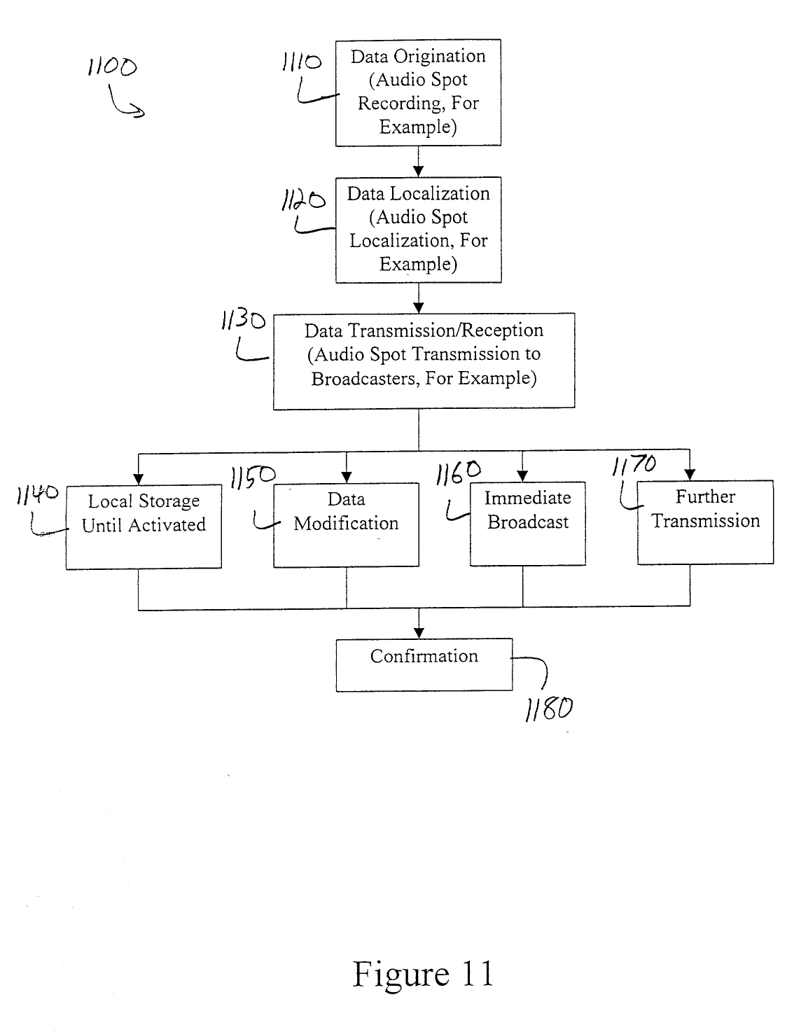

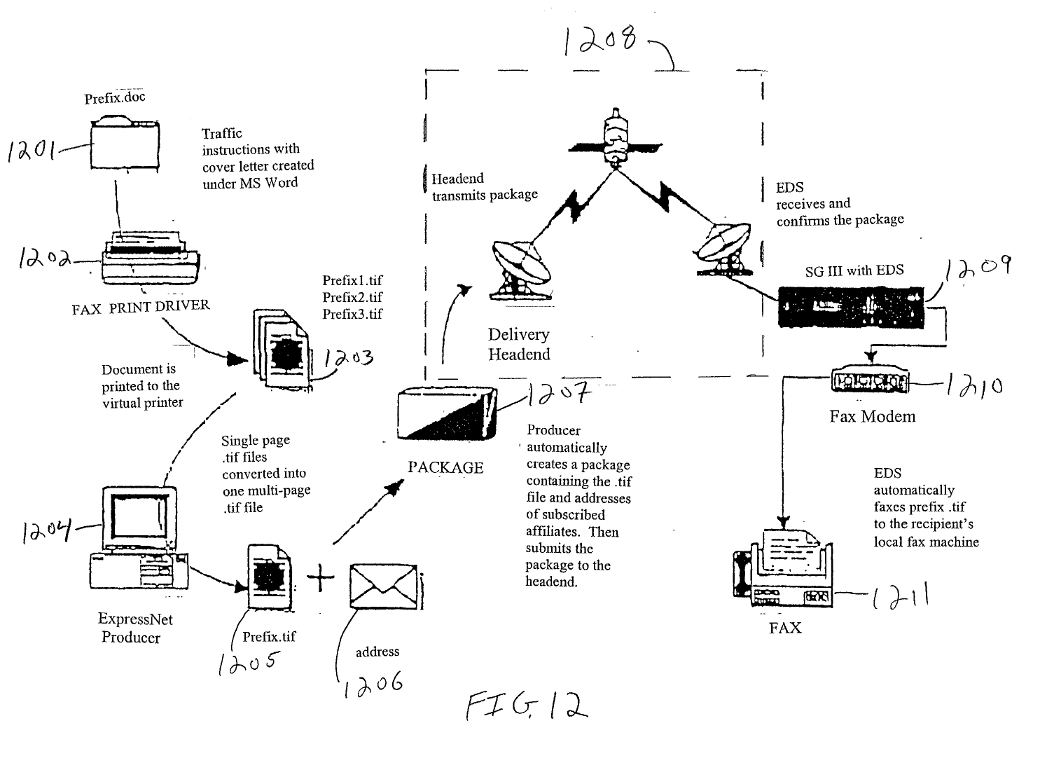

Additionally, as illustrated in the flowchart 1100 FIG. 11, the preferred embodiment may be employed to distribute data or content, for example, audio advertising, from a centralized origination location to a number of geographically diverse receivers. A particular example of such a data distribution system is the distribution of audio advertising, particularly localized audio spots comprising a national advertising campaign. First, at step 1110 content data is originated. For the audio spot example, the audio spots may be recorded at a centralized origination location such as a recording studio or an advertising agency. Next, at step 1120, the content data is localized. For the audio spot example, the audio spot is localized by, for example including the call letters of a local receiver or including a reference to the region. Next, at step 1130, the content data is transmitted to and received by a remote receiver. For the audio spot example, the audio spot may be transmitted for geographically diverse broadcast receivers via a satellite data transmission system. Once the content data has been received by the remote receiver, the content data may be stored locally at the receiver step 1140, the content data may be modified at the receiver at step 1150, the content data may be immediately broadcast at step 1160, or the content data may be further transmitted at step 1170, via a LAN for example. For the audio spot example, the audio spot may be stored at the receiver, the audio spot may be modified, for example by mixing or cross fading the audio spot with a local audio signal, the audio spot may be immediately broadcast, or the audio spot may be further transmitted via a network such as a LAN or downloaded from the receiver. Finally, at step 1180, a confirmation may optionally be sent to the data origination location. The confirmation may indicate that the content data has been received by the receiver. Additional confirmations may be sent to the data origination location when the content data is broadcast as in step 1160, or further transmitted as in step 1170, for example. For the audio spot example, a confirmation may be sent when the spot is received and additionally when the spot is broadcast or further transmitted, for example. A preferred embodiment of the present invention thus provides a distribution system providing reliable, fast and efficient delivery of content as well as increased automation capability throughout the system. For the audio spot example, increased automation, ease of use and speed of distribution of a national ad campaign to a number of local broadcasters may allow increased broadcast advertising and may draw major advertising expenditures into national broadcasting advertising campaigns.

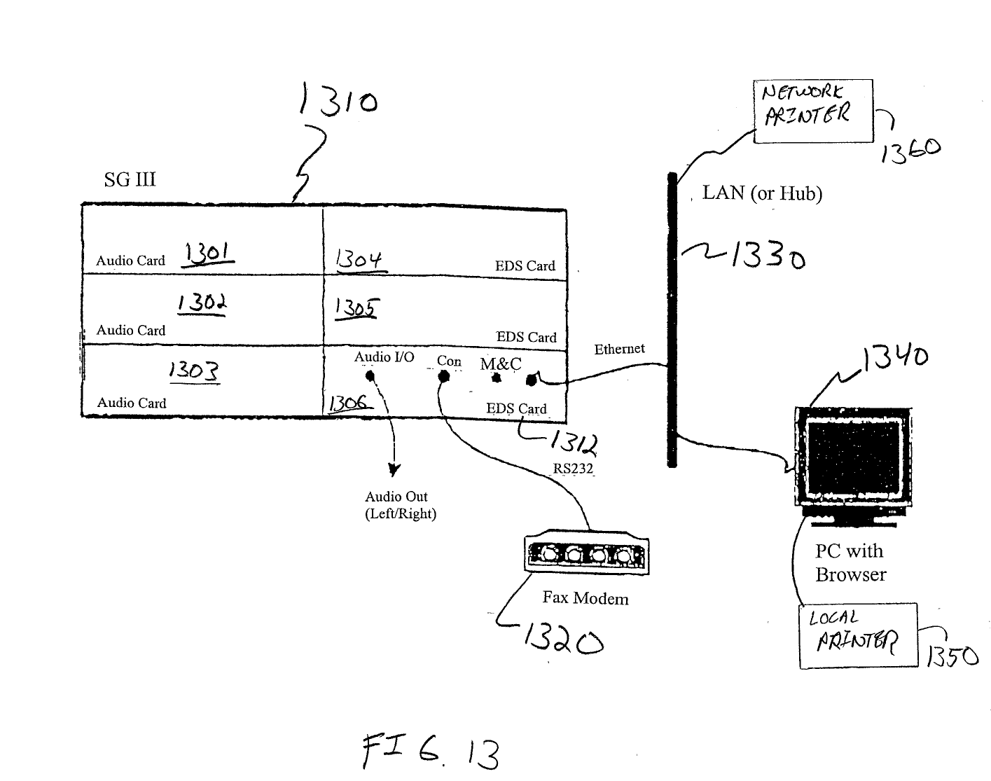

FIG. 12 illustrates a system 1200 for providing fax services over a satellite network using the EDS card 100 according to an embodiment of present invention. In the system 1200 of FIG. 12, a document 1201 is transmitted over a satellite transmission system 1208 to a recipient 1211. The system 1200 may be used, for example, 1) to provide a virtual private network for faxes to increase security and on-time deliverability of faxes, 2) to replace transmission over standard telephony resources when the standard resources are faulty or intermittent, 3) to minimize costs associated with faxing by directly transmitting faxes over the satellite network to a local fax machine for transmission to a local user, and 4) to provide easy record keeping or backup of faxes.

Turning to FIG. 12, first, a document 1201 to be faxed is prepared by a user at a terminal. For example, the user may prepare the document 1201 using a word processor such as Microsoft Word®. The user also enters traffic instructions for the document 1201 at the terminal. The traffic instructions may include the destination fax number for the recipient 1211, the time at which the fax is to be transmitted, client information for billing purposes, or destination information such as individual or company information. FIG. 12 illustrates a single user generating a single document 1201, however, the system 1200 may service a number of users simultaneously, as further described below.

Next, the user sends the document 1201 to be faxed and the traffic instructions to a virtual fax print driver 1202. The virtual fax print driver 1202 is preferably a software driver that is preferably installed on the user's terminal or is available to the user via a network connection. The virtual fax print driver 1202 converts the document 1201 received from the user into a format, such as the Tagged Image File Format (TIFF) .tif format, that is suitable for transmission over a fax network. The conversion of the document to .tif format may occur on a page-by-page basis into a sequence of individual tif files 1203 and the individual .tif files 1203 may then be combined to form a single large .tif file, as further described below. For example, when the document is converted into a sequence of tif files, each of the .tif files in the sequence preferably has a name including a prefix and a number. The prefix is the same for each file in the sequence while the number identifies the page number of the tif document in the original file. Alternatively, the entire document may be converted into a single .tif file automatically by the virtual fax print driver 1202.

As mentioned above, the system 1200 may service a number of users simultaneously. For example, a number of networked users may send documents to be faxed and traffic instructions to a single virtual fax print driver. Additionally, the virtual print driver may be based on currently available fax print drivers such as the Ibex fax print driver.

Next, the single .tif file or sequence of .tif files and the traffic instructions are sent to the ExpressNet producer 1204. If the document is received by the ExpressNet producer 1204 as a sequence of .tif files, the ExpressNet producer 1204 then converts the sequence of .tif files into a single .tif file. Alternatively, the sequence of .tif files may be sent as multiple files to the affiliate. Preferably the affiliate receives the multiple .tif files, sorts the .tif files and then faxes the .tif files to the recipient.

Once the document to be faxed is rendered as a single .tif file, the ExpressNet producer 1204 then compares the traffic information received from the user with a stored address list. The stored address list may include, for example, the numbers and locations of the fax machines or fax modems that are affiliates of the system 1200. By comparing the traffic information to the stored address list, the ExpressNet producer 1204 determines the destination affiliate to direct the document for faxing. The ExpressNet producer 1204 then forms a package 1207 that includes the document and the destination information. The ExpressNet producer 1204 may be a Transportal 2000 producer, for example, which is a high speed digital media delivery system or a “store and forward” system.

For example, the document generated by the user may be destined for a recipient in the “312” area code. The user may enter the “312” area code as traffic instructions at the user's terminal. The area code is received by the ExpressNet producer 1204. The stored address list on the ExpressNet producer 1204 may include a list of affiliates for each area code. Each affiliate may be a fax machine or fax modem in the desired area code that may be used to transmit the document to be faxed from the affiliate in the areas code to the fax machine of the intended recipient. The ExpressNet producer 1204 may then determine the affiliate located in the “312” area code. Once the ExpressNet producer 1204 has located the affiliate, the document to be faxed is then routed to the affiliate for fax transmission to the recipient. The routing, to an identified affiliate, of the document to be faxed preferably occurs transparently to the user. That is, the user need not be aware of the internal workings or the affiliate location or structure. The routing of the document to be faxed preferably occurs at the ExpressNet producer 1204 without intervention by the user.

Alternately, the document to be faxed may be routed based on recipient information other than the fax number. For example, the document may be routed based on business name so that when an affiliate receives a document to be faxed to “XYZ Corp”, for example, the affiliate faxes all documents addressed to XYZ Corp. to a single, predetermined fax number. In this way, the traffic instructions need not pass the recipient's fax number to the affiliate, only the business name is used as the destination.

The package 1207, including the document to be faxed, the destination affiliate and the recipient information, is then transmitted to the head end of a satellite transmission system 1208. The operation of the satellite transmission system is described in detail FIGS. 8 and 9 and in U.S. patent application Ser. No. 09/287,200, filed Apr. 3, 1999, entitled “Satellite Receiver/Router System and Method of Use”, which is hereby incorporated by reference in its entirety. The package 1207 passes through the satellite transmission system 1208 and is uplinked to a satellite and then downlinked to the destination affiliate that was selected by the ExpressNet producer 1204. At the destination affiliate, the package 1207 is received and passed to the EDS 1209. The EDS 1209 unpackages the package 1207 and determines the recipient information, especially the recipient fax number to which the document is to be transmitted. Alternatively, as mentioned above, the package 1207 may be unpackaged and then faxed to a recipient based on the recipient's name or business name contained in the document. That is, the recipient's name may be compared to a cross reference listing of names and fax numbers and the document may be sent to the fax number corresponding to the recipient's name. The EDS 1209 then passes the document to a fax machine or fax modem 1210 for transmission to the recipient 1211. For example, the EDS 1209 may dial the recipient's fax number using the fax modem 1210 and then transmit the document to the recipient 1211.

With regard to the .tif file generated by the virtual fax print driver, preferably, the .tif file is compatible with the Consultive Committee on International Telephone and Telegraph (CCITT) Group 3 standard sometimes referred to as “TIFF-F”. The data in CCITT/3 fax files is compressed using one-dimensional Huffman encoding scheme. Huffman encoding converts characters into variable length bit strings and because bits are encoded instead of bytes, an end-of-line (EOL) token may end in the middle of a byte. The process of byte alignment adds extra zero bits in order for each encoded scan line of the document 1601 to begin on a byte boundary. Each encoded scan line also contains EOL characters. Data may also be stored byte-packed. The .tif files are preferably formatted for a “standard” resolution of 98 dots-per inch (dpi) or 196 dpi, letter size pages (A4), and in black and white. Also, the .tif files may preferably be single page or multiple pages.

With regard to the stored address list at the ExpressNet producer 1204 the address list is preferably defined at setup and may be edited at any time. For example, the address list may be edited to include new affiliates that become part of the system 1200, or to include new EDS cards that may be added at an existing affiliate. Additionally, a global address book may be shared by all producers and/or all affiliates. The global address book may be stored at each producer and/or affiliate and entries may be updated at a local producer and/or affiliate and then posted to the other producers and/or affiliates for storage. For example, when a new client is added to the system, the client's information may be added to the global address book at a producer situated at a control operations center. The new global address book may then be sent to each producer and affiliate for local storage and use.

The fax modem 1210 is preferably an analog fax modem with a rate of 28800 baud or higher and is CCITT Group 3/Class 1 fax compatible. The fax machine or fax modem preferably supports the CCITT T.30 minimum capabilities for Group 3, for example, a “standard” resolution of 98 dpi, A4 letter size pages, and support V.27ter at 4800 bps or higher. If the fax modem attempts to transmit to the recipient's fax machine but fails, the fax modem preferably automatically retries. The number of retried attempts and the time interval between these attempts may be configured by a user. For example, the system may be configured to retry 10 times with a time interval of 1 minute between attempts.

Alternatively, the affiliate may communicate with a plurality of fax modems to send faxes to multiple recipients simultaneously. For example, if an affiliate includes two fax modems, a received document to be faxed to a recipient may be directed to either fax modem or the fax modem that is not currently transmitting a fax. Thus, at an affiliate requested by the ExpressNet Producer, the affiliate may preferably route a received document to any available fax modem. Such routing may occur using TCP/IP protocols over a LAN connection, for example.

In another embodiment, the system 1200 may include two affiliates in a single area code, for example, in order to support high usage rates within the area code. In this embodiment, the two affiliates may transmit information concerning their level of use back to the ExpressNet Producer so that the ExpressNet Producer may direct faxes to the lesser used affiliate. Alternatively, a single affiliate may include two EDS cards that share a single fax modem.

Additionally, the EDS 1209 preferably records all fax attempts, successful or not, in an activity log. The activity log may also be configured to record destination information and length of fax information. Additionally, the EDS 1209 may be configured to transmit a re-send signal to the ExpressNet Producer if received fax includes an error. Additionally, the EDS may transmit an alert signal to the ExpressNet Producer when a fax is unable to be transmitted, for example due to received failure at a recipient's fax machine.

Additionally, the success or failure of a fax transmission is reported back to the producer. The producer may then retry the fax, as discussed above, or may sent a confirmation to a user at the producer. Alternatively, tracking of faxes may not be automatic, but may occur upon request of the user at the producer.

Additionally, once the affiliate receives the fax from the producer, the affiliate may e-mail the fax to a recipient rather than fax the fax to the recipient. As further discussed below, the affiliate may be equipped with a connection to a Local Area Network (LAN) or other network and may forward to mail to a mail server or a PC connected to the network. Additionally, the affiliate may retain the fax in a built-in web server on the EDS card at the affiliate. The fax may then be retrieved from the EDS card via a web browser, for example, for remote display at the recipient's desktop. Additionally, faxed that are received by the affiliate may be printed via a printer attached to the LAN.

Additionally, the producer may be configured to associate fax documents with a predetermined list of recipients rather than a single recipients. For example, a user may direct a fax to a destination group of recipients such as franchisees in the New England area, for example. The producer may receive the destination group information and compare the destination group title to a listing of recipients to determine the actual individual recipients. Once the producer has determined the individual recipients, the producer may then copy and send the fax to each individual recipients. The recipients may be anywhere throughout the network and need not be situated at a single affiliate.

Prior art systems were either not able to provide faxing or could only fax with substantial additional modification and/or overhead. That is, prior system were not designed to support faxing and were able to do so, if at all, only after significant modification that often impaired the ability of the system to function. In contrast, the present application provides seamless faxing ability integrated with any other types of data transfer, storage, and re-transmission via LAN, local PC, or fax modem, for example. Preferably, these functions are all available through a single removable (or field insertable) card that may also provide local storage and Ethernet output into a pre-existing system so as to build off of presently installed systems, or to allow the integration of the card with the deployment of new systems. Thus, the present application may be scaled to match the user's demand and may be upgraded with additional capacity as the user's demands increase.

FIG. 13 illustrates a wiring diagram 1300 for an affiliate system according to a preferred embodiment of the present invention. The wiring diagram 1300 includes a satellite receiver 1310, a fax modem 1320, a Local Area Network (LAN) 1330, a PC 1340 preferably including a browser, a local printer 1350 at the PC 1340, and a network printer 1360. The satellite receiver 1310 includes six slots 1301—1306, but is not limited to having any number of slots. Each slot 1301-1306 may have an installed card such as an audio card or an EDS card, for example. In FIG. 13, one of the slots 1301-1306 includes an installed EDS card 1312. The EDS card 1312 includes an Audio I/O port 1322, a communication port 1324, a M&C port 1326, and an Ethernet port 1328.

The fax modem 1320 communicates with the EDS card 1312 through the communication port 1324. Additionally, the EDS card 1312 communicates with the LAN 1330. The PC 1340 also communicates with the LAN 1330.

In operation, the package of documents to be faxed and destination information are received by the receiver 1310 and sent to the EDS card 1312. As described above, the EDS card 1312 unpackages the package to access the destination information. The EDS card 1312 then sends control signals to the fax modem 1320 to initiate a dialing sequence at the fax modem. Once the fax modem has initiated a connection with a recipient, the document is sent from the EDS card 1312 to the fax modem 1320 for transmission.

Alternatively, a received document may be routed to the LAN 1330 instead of the fax modem 1320. For example, the EDS card 1312 may be directly connected via the LAN 1330 to a corporate network, for example. The documents to be faxed are received as .tif filed and may be unpacked and directed to the corporate network or an individual PC or e-mail address on the corporate network. The documents in .tif format may then be easily displayed through commercially available imaging software.

Additionally, documents received by the EDS card 1312 may be stored at the EDS card 1312 for later transmission or retrieval. For example, documents may be stored at the EDS card 1312 and then viewed from the LAN or sent to the network printer 1360.

Also, as mentioned above, the EDS card 1312 may be configured to respond to a producer to indicate the status of a received document. Foe example, the EDS card 1312 may indicate to the producer whether the sent document was received successfully or unsuccessfully and whether to retry sending the document. Alternatively, the EDS card 1312 may simply store the status of the received document, for example as successful or unsuccessful, and then await a status request from a producer. When a producer requests the status of a document, the EDS card 1312 may respond whether the document was successfully received.

The PC 1340 may be used to interact with and configure the EDS card 1312 and fax modem 1320 via the LAN 1330. For example, the operation of the receiver 1310 and the EDS card 1312 may be accessed and displayed via a web browser installed on the PC 1340. Through the web browser, a user may configure the number of retries for the fax modem, for example.

Additionally, as discussed above, the PC 1340 may be used to access faxed documents that may be stored on the EDS card 1312. The documents may be displayed at the PC via a browser installed on the PC. Additionally, the documents may be printed at the PC by the local printer 1350.

Also, documents that are sent to the EDS card 1312 may be sent via the LAN 1330 to the network printer 1360 for distribution. The network printer 1360 may be near the EDS card 1312 or may be far away from the EDS card 1312 (for example, in another building) as long as the network printer 1360 is able to access the EDS card 1312 via the LAN 1330.

In an alternative embodiment, multiple EDS cards may be installed in the receiver 1310. Each EDS card may be equipped with its own fax modem. Alternatively, a plurality of EDS cards may utilize a single fax modem. Additionally, the plurality of EDS cards may communicate with each other via the LAN 130.

In an additional embodiment, the fax modem may be connected to the LAN rather than directly to the EDS card. The EDS card may control the fax modem through the LAN 1330.

Additionally, as described above, the EDS card 1312 is equipped with internal storage. The internal storage allows received packages and documents to be stored. For example, a received document may be stored for fax transmission at a later time.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features, which come within the spirit and scope of the invention.

[image]

[image]

[image]

[image]

[image]

[image]

[image]

[image]

[image]

[image]

[image]

[image]

1. A satellite-based fax distribution system including:
a producer receiving a document to be faxed and traffic instructions for said document, said producer determining an affiliate based on said traffic instructions and directing said document to said affiliate through a satellite;
a satellite receiving said document from said producer and transmitting said document to said affiliate; and
an affiliate receiving said document and faxing said document to a recipient.

2. The system of claim 1 wherein said traffic instructions include recipient information identifying said recipient.

3. The system of claim 1 wherein said recipient information is sent to said affiliate.

4. The system of claim 1 wherein said producer receives said document from a virtual fax print driver.

5. The system of claim 1 wherein said affiliate includes a memory for storing said document.

6. The system of claim 1 wherein said affiliate stores information concerning said document.

7. The system of claim 1 wherein said affiliate notifies said producer of the status of said document received by said affiliate.

8. A method for distributing faxes via a satellite-based fax distribution system, said method including:
receiving a document to be faxed;
receiving traffic instructions regarding said document;
determining an affiliate based on said traffic instructions at a producer;
directing said document to said affiliate through a satellite;
receiving said document at said affiliate; and
faxing said document from said affiliate to a recipient.

9. The method of claim 8 wherein said traffic instructions include recipient information identifying said recipient and said recipient information is sent to said affiliate.

10. The method of claim 8 wherein said producer receives said document and said traffic instructions from a virtual fax print driver.

11. The method of claim 8 further including storing said document at said affiliate.

12. The method of claim 8 further including storing information regarding said document at said affiliate.

14. The method of claim 8 further including notifying said producer of the status of said document received by said affiliate.

15. An affiliate in a satellite-based fax distribution system, said affiliate including:
a receiver for receiving a document from a producer over a satellite communication link, said document routed from said producer to said receiver by traffic instructions;
a fax system for faxing said document to a recipient.

16. The affiliate of claim 15 wherein said traffic instructions include recipient information identifying said recipient and said recipient information is sent to said affiliate.

17. The affiliate of claim 15 further including a memory for storing said document.

18. The affiliate of claim 15 further including a memory for storing information regarding said document.

19. The affiliate of claim 15 wherein said receiver notifies said producer of the status of said document received by said affiliate.

20. An Ethernet Digital Storage (EDS) Card for use in a satellite-based fax distribution system, said EDS card including:
a flash memory storage for storing at least a portion of a received document; and
a command processor sending said document to a fax system for transmission.

21. A satellite-based fax distribution system including:
a producer in communication with a satellite, said producer receiving a document to be faxed and traffic instructions for said document, said producer determining a plurality of remote affiliates based on said traffic instructions and directing said document to said plurality of remote affiliates through said satellite;
a satellite receiving said document from said producer and transmitting said document to said plurality of remote affiliates; and
a plurality of remote affiliates,
whereby said plurality of remote affiliates receive said document from said satellite, and
whereby said plurality of remote affiliates faxes said document to a plurality of remote recipients.

22. The system of claim 21 wherein said traffic instructions include recipient information identifying said plurality of remote recipients.

23. The system of claim 21 wherein said recipient information is sent to said plurality of remote affiliates.

24. The system of claim 21 wherein said producer receives said document from a virtual fax print driver.

25. The system of claim 21 wherein at least one of said plurality of remote affiliates includes a memory for storing said document.

26. The system of claim 21 wherein at least one of said plurality of remote affiliates stores information concerning said document.

27. The system of claim 21 wherein at least one of said plurality of remote affiliates notifies said producer of the status of said document received by said affiliate.
